(19) United States
(12) Patent Application Publication
(10) Pub. No.: US 2026/0195413 A1
(43) Pub. Date: Jul. 9, 2026

(54) STAGED MACHINE LEARNING FRAMEWORK FOR CLUSTERING CLASSIFIER PREDICTIONS

(71) Applicant: OPTUM, INC., Minnetonka, MN (US)

(72) Inventors: Rahul BHASKAR, Irvine, CA (US); Vaibhav KAKKAR, Irvine, CA (US); Mohit SINGHAL, Delhi (IN); Arun Kumar TIWARI, Delhi (IN); Amardeep SHARMA, Delhi (IN); Mohit KUMAR, Gautam Buddha Nagar (IN)

(21) Appl. No.: 19/012,170

(22) Filed: Jan. 7, 2025

(51) Int. Cl. G06F 18/23213

(52) U.S. Cl. CPC G06F 18/23213; G06F 16/212; G06F 16/285

(57) ABSTRACT

Various embodiments of the present disclosure provide a hybrid machine learning process that improves the functionality of a computer in various aspects. The techniques comprise generating, using a supervised machine learning model of a connected model framework, a predictive feature for an entity of a set of entities based on a set of entity attributes corresponding to the entity. The techniques comprise generating, using a clustering model of the connected model framework, a refined entity cluster by (i) generating an initial cluster for the entity that comprises a first subset of the set of entities, (ii) generating, based on the predictive feature, a coefficient of variation for the initial cluster, and (iii) generating the refined cluster from the initial cluster based on the coefficient of variation. The techniques comprise generating a modified predictive feature for the entity based on the refined cluster.

### BACKGROUND

Various embodiments of the present disclosure address technical challenges related to machine learning technology, including the application of machine learning in automated predictive processes. In various domains, machine learning models are used to generate predictions that may be used by downstream models for performing one or more operations and/or interactions outside the model and/or computing environment. Traditionally, machine learning models are specialized for a particular prediction by adjusting weights, coefficients, parameters, and/or the like of the model to improve the accuracy, recall, precision, or other performance metrics with respect to a particular set of defined features. This causes traditional models to generate predictions specific to a particular target, which leads to several technical challenges when generalized predictions are beneficial for downstream processes—especially when predictions are needed that generalize to a subset of defined features that may or may not overlap with the highest weighted portions of a model.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a connected model framework in accordance with some embodiments of the present disclosure.

FIG. 5 depicts an operational example of a sequential clustering approach in accordance with some embodiments of the present disclosure.

FIG. 6 depicts a flowchart diagram of an example hybrid machine learning process in accordance with some embodiments of the present disclosure.

### DETAILED DESCRIPTION

Embodiments of the present disclosure provide machine learning frameworks and architectures that improve the functionality of a computer with respect to various computing tasks, including integration of supervised and clustering models to generate normalized predictive values for an entity population. To do so, some embodiments of the present disclosure provide a connected model framework that defines a specific arrangement of supervised and clustering models to generate improved predictions, such as a modified predictive feature, using less computing resources and achieving a higher degree of accuracy in predictions. To overcome performance deficiencies with traditional machine learning models, such as standalone supervised or clustering approaches, the connected model framework defines a multi-stage process in which preliminary predictions are generated based on attributes associated with a singular entity and modified predictions are generated based on correlations within a set of entities. By doing so, the connected model framework improves prediction accuracy with respect to interrelated entities and enables integration of the connected model framework with downstream models that implement the modified predictions.

Machine learning models, such as supervised and/or clustering (e.g., unsupervised) models, may be implemented in a vast number of different model architectures that are each designed with specific goals, in terms accuracy, speed, and efficiency with respect to different tasks. Traditionally, such models may be implemented as standalone models specifically designed for a particular task. By themselves, supervised machine learning models may excel at individual entity-level predictions but lack the capability to generate predictions for an entity based on correlations between the entity and other related entities. On the other hand, clustering model (e.g., that may be unsupervised) may excel at correlations between related entities but lack the capability to generate entity-level predictions. To address these deficiencies, the connected model framework of the present disclosure implements a connected framework in which supervised machine learning techniques may detect entity-level features for downstream unsupervised techniques. In this manner, the connected model framework may leverage a supervised machine learning to offset disadvantages of an unsupervised machine learning approach and/or other clustering approaches, while the clustering approaches counteract the disadvantages of the supervised machine learning. By doing so, the connected model framework may automatically generate predictions for an entity that robustly leverages attributes of the entity as well as correlations between the entity and other related entities. At the same time, using the techniques of the present disclosure, the connected model framework may generate modified predictive features that may be used and/or implemented in downstream models while using less computing resources than traditional machine learning models.

Examples of technologically advantageous embodiments of the present disclosure comprise an improved distribution of machine learning functionality that combines supervised and clustering approaches within a single connected model framework to overcome challenges in machine learning. This, in turn, enables improvements in machine learning technology that may be practically applied in various contexts (e.g., goal predictions) to create accurate predictions that generalize to a population of data points such that they address biases in machine learning without drop-offs in machine learning performance (e.g. in terms of accuracy). Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

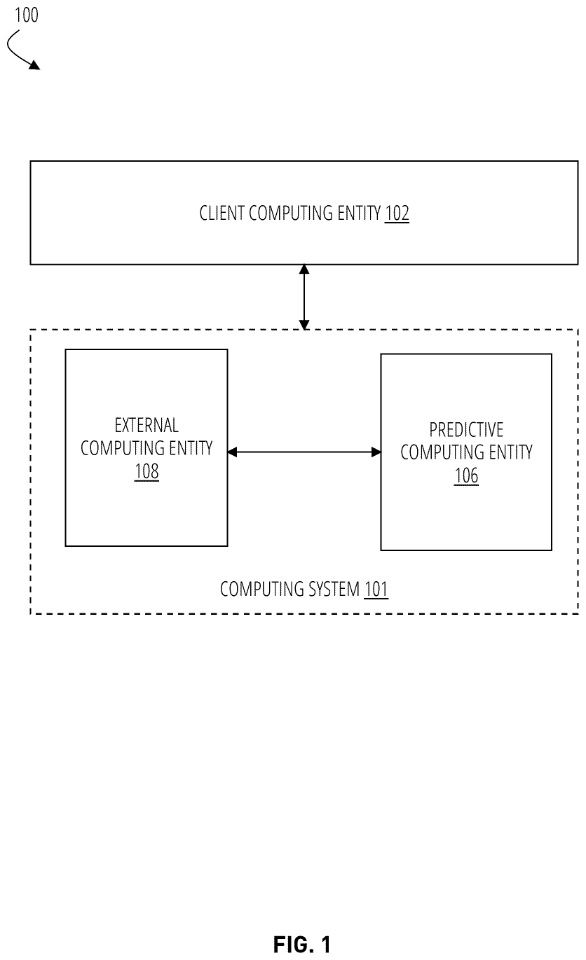

FIG. 1 depicts a block diagram of an example architecture 100 in accordance with some embodiments of the present disclosure. The architecture 100 comprises a computing system 101 configured to receive entity attributes from client computing entities 102, process the entity attributes to generate a modified predictive feature, and provide the modified predictive feature to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate predictive outputs and/or other machine learned outputs. The models may be adapted to a connected model framework comprising hybrid supervised and clustering models to generate an output. Some techniques of the present disclosure may adapt traditional models to a connected model framework for more efficiently handling portions of the request handling process.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques machine learning techniques described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as entity attributes, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

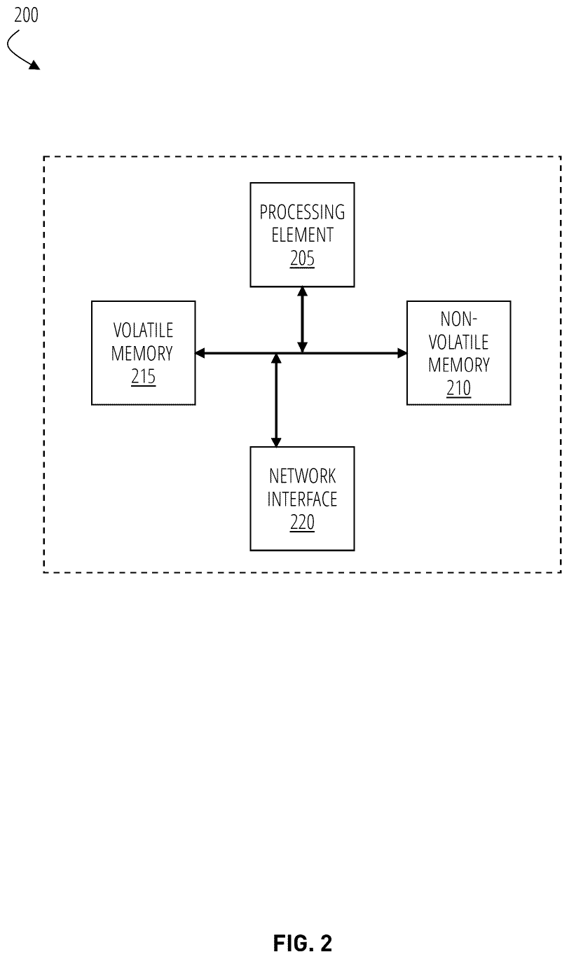

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computing entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1 xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

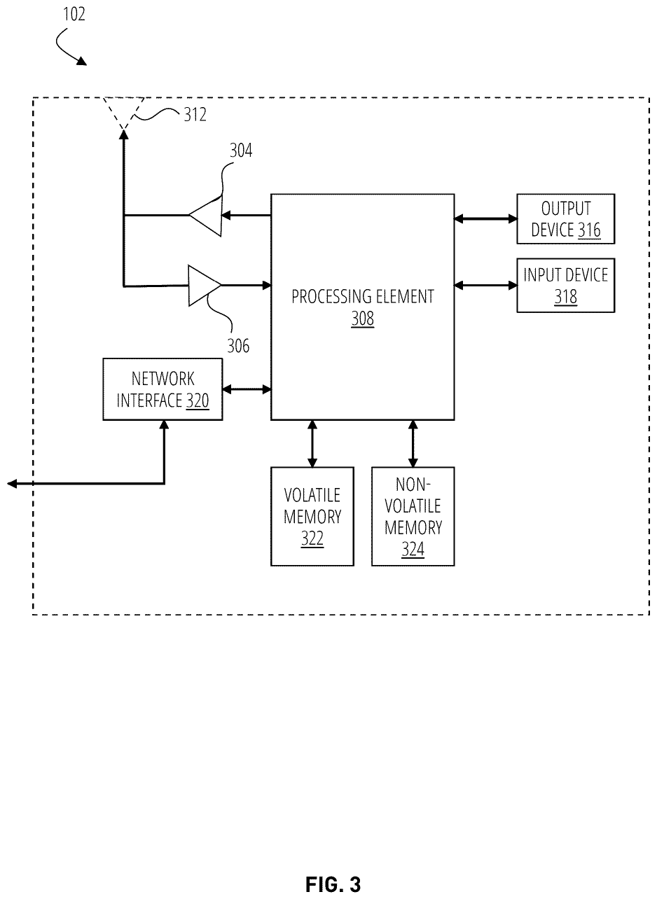

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322, non-volatile memory 324, quantum memory, and/or the like. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to machine learning frameworks. In particular, systems and methods are disclosed herein that implement hybrid machine learning techniques in a connected model framework. By doing so, the hybrid machine learning techniques of the present disclosure enable improved predictions while reducing computing resource consumption. This, in turn, may improve the functionality of a computer with respect to various computing tasks, including increased functionality, machine learning, integration with downstream models, and/or the like.

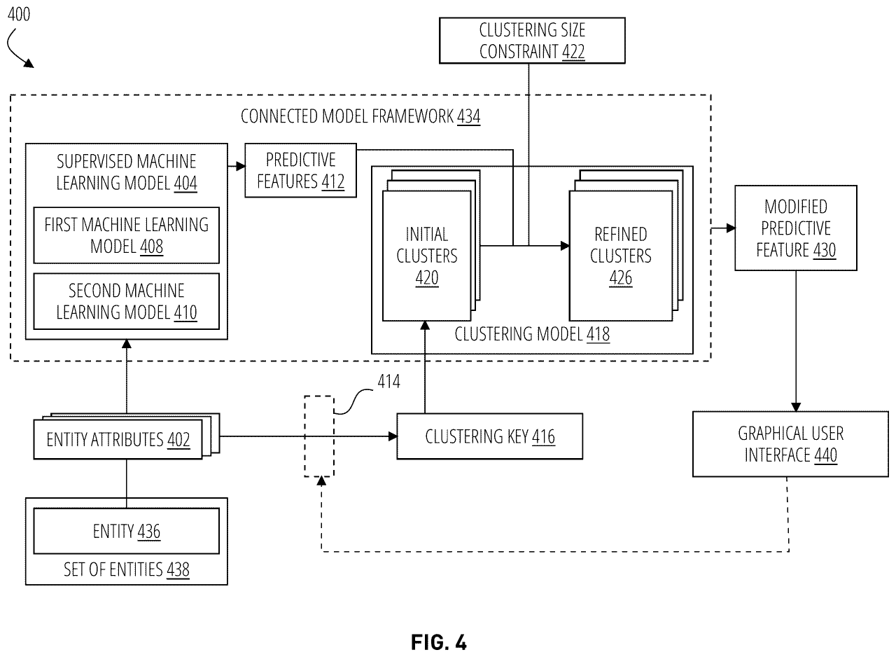

FIG. 4 depicts a dataflow diagram 400 of an example connected model framework in accordance with some embodiments of the present disclosure. As depicted, the example connected model framework 434 combines at least one supervised machine learning model(s) 404 with at least one clustering model 418 to collectively generate a modified predictive feature 430 from a set of entity attributes 402. To address technical challenges in machine learning, the connected model framework 434 arranges the supervised and clustering models into a hybrid structure that sequentially makes predictions for an entity at an individual and cohort level. By doing so, the connected model framework 434 may be implemented by a computing system, such as the computing system 101, to generate a sequence of granular-to-normalized predictions that are accurate at an entity-level while generalizing to segments of interest with a set of entities 438. As described herein, the segment of interest may be dynamically defined, using a clustering key 416 to address bias, and other machine learning performance deficiencies, as they detected in machine learning outputs. In this way, the hybrid machine learning framework of the connected model framework 434 improves the performance of computers, systems, machine learning models, and/or the like associated with various predictive processes.

In some embodiments, at a first stage of the connected model framework 434, the computing system 101 generates a predictive feature 412 for an entity 436 of a set of entities 438 based on up to each of a set of entity attributes 402 corresponding to the entity 436. An entity 436, for example, may comprise an individual data object within a set of data objects. The data object may be domain and/or task specific. For instance, in some domains, an entity 436 may comprise an individual or a collection of individuals for which a predictive feature 412 is generated. In other domains, the entity 436 may comprise an object, such as a computer, building, and/or the like. In a clinical example, the entity 436 may identify a healthcare provider (and/or a collection of providers) that provide services to one or more members within a healthcare system. The entity 436, for example, may identify one or a subset of healthcare providers within a healthcare system that comprises a set of healthcare providers (e.g., a set of entities 438) that complete in-office assessments for a population of members. As another example, in a computer infrastructure domain, the entity 436 may identify a computer within a networked computing environment in which a set of computing devices (e.g., set of entities) are used to perform a set of computing tasks for a population of members.

In some embodiments, the entity 436 is associated with a set of entity attributes 402. The set of entity attributes 402 may comprise one or more data values of one or more different data types that record a characteristic for a particular entity 436. For example, an entity attribute 402 may comprise an entity identifier that uniquely identifies the entity 436 within a particular domain. Additionally, or alternatively, an entity attribute 402 may comprise a geographic attribute that describes a geographic location (e.g., physical address, geographic coordinates, geographic region) at which the entity 436 is physically located (e.g., administers in-office assessment). For example, a geographic attribute may identify a city, state, region, country, and/or the like in which an entity (and/or one or members associated therewith) is physically located.

In addition, or alternatively, the entity attribute 402 may comprise a communication channel attribute that describes a channel of a communication framework through which the entity 436 interacts and/or engages with one or more other entities and/or members thereof. For example, in a clinical use case, an entity communication channel may be one or more of a healthcare advocate (HCA) related communication framework, a provider support center-priority (PSC-P) related communication framework, a provider support center-bulk (PSC-B) related communication framework, and/or the like. In addition, or alternatively, in a computer infrastructure channel, the entity communication channel may be one or more wireless interfaces, such as those described herein.

In some examples, the entity attribute 402 may comprise a deployment channel attribute that describes a medium through which the entity 436 interacts and/or engages with one or more other entities and/or members thereof. For example, an entity deployment channel may be an electronic medium (e.g., virtual calls), a physical medium (e.g., office visits), and/or the like. A deployment channel attribute, for example, may comprise one or more relative frequency metrics for up to each of a set of defined deployment mediums (e.g., virtual, physical, hybrid).

As other examples, the entity attribute 402 may comprise a historical predictive feature that describes a historical predictive feature (and/or ground truth observation for a historical predictive feature); one or more member value attributes that describe visit (and/or use, access, and/or the like) patterns of a number of members of an entity (e.g., a number of times, a frequency, and/or one or more population derivatives thereof, of one or a cohort of members have visited an entity 436); a documentation attribute that describes a medical claim, a vulnerability report, and/or the like that describes a documented event for an entity 436; a condition attribute that describes an investigation condition, such as a suspicious healthcare provider, a vulnerable computing node, and/or the like; a bandwidth and/or capacity attribute that describes a processing load of an entity 436 (e.g., number of healthcare providers, number of processors); a specialty attribute that describes an specialization of an entity 436 (e.g., a specialized healthcare provider, a specialize computing device), and/or the like. In some examples, up to each of the set of entity attributes 402 may comprise dependent feature for a target features, such as the predictive feature 412 and may thus be domain specific and/or based on the predictive feature 412.

In some embodiments, the predictive feature 412 is an entity-level output of the supervised machine learning model 404 that is based on a set of entity attributes 402 for the entity 436. The predictive feature 412, for example, may comprise a binary value, a probabilistic value, categorical value, and/or the like that reflects a prediction for a particular entity 436. The prediction, and/or data type thereof, may be based on a prediction domain and/or the supervised machine learning model 404. For instance, in a healthcare domain in which the entity 436 is a healthcare provider, the predictive feature 412 may comprise a predicted return rate for in-office assessments (e.g., a total, percentage of population, or average number of in-office assessments performed) by a healthcare provider over at time period. As another example, in a computer infrastructure domain, the predictive feature 412 may comprise a predicted lifespan for a computing device, and/or the like.

In some examples, the predictive feature 412 corresponds to a prediction time window that identifies a future time point, time interval, and/or the like that bounds the predictive feature 412. For example, the prediction time window may comprise a one-year time period and the predictive feature 412 may comprise a value that corresponds to the end of the one-year time period (e.g., a total, percentage of population, or average number of in-office assessments performed over a one-year time period). The prediction time window may be specific to a particular prediction domain and may include any time period, such as a daily time period, weekly time period, monthly time period, and/or the like.

In some embodiments, the supervised machine learning model 404 comprises a supervised model set (e.g., up to each of which may determine predictions for a different set of classifications and/or values or that may be other members of a model ensemble that collectively determine the predictive feature 412) that comprises a first machine learning model 408, a second machine learning model 410, and/or the like. In some examples, responsive to a first attribute of the set of entity attributes 402 meeting or exceeding a time threshold, the computing system 101 may generate, using the first machine learning model 408 of the supervised model set, the predictive feature 412 for the entity 436. In addition, or alternatively, the computing system 101 may generate, using the second machine learning model 410 of the supervised model set, the predictive feature 412 for the entity 436.

In some examples, the time threshold is associated with a historical data threshold for the entity 436. For example, the time threshold may indicate a threshold period of time for which historical data is stored for a particular entity 436. In some examples, time threshold may correspond to the prediction time window. For example, a time threshold for a one-year prediction time window may comprise a one-year time threshold, and/or the like. In some examples, the computing system 101 may leverage the time threshold to route an entity 436 (and/or the set of entity attributes 402 thereof) to one of the first machine learning model 408 and/or the second machine learning model 410 based on a level of historical data associated with the entity 436. By doing so, the supervised machine learning model 404 may comprise a multiple machine learning models that account for different levels of predictive information available for the entity 436. For example, the first machine learning model 408 may be configured to generate the predictive feature 412 using the set of entity attributes 402 that comprise historical observation over a time threshold. In addition, or alternatively, the second machine learning model 410 may be configured to generate the predictive feature 412 using the set of entity attributes 428 and/or a normalized supplemental attribute for the entity 436 to compensate for a lack of historical data. By way of example, using a clinical use case, the first machine learning model 408 may be trained (e.g., fit) based on a historical performance (e.g., historical in-office assessment yearly rates) of a particular healthcare provider. To compensate for a lack of data reflective of the historical performance of a particular healthcare provider, the second machine learning model 410 may be trained (e.g., fit) using normalized supplemental attributes (e.g., average historical return rates for healthcare providers at a region level) that approximate the historical performance of a particular healthcare provider.

In some embodiments, the first machine learning model 408 and/or second machine learning model 410 of the supervised machine learning model 404 comprise parallel models with the same or different model architectures that respectively describe parameters, hyper-parameters, and/or defined operations of one or more machine learning models (e.g., models comprising at least one of one or more activation layers, one or more aggregation layers, one or more layers that depend on trained parameters, coefficients, and/or the like) configured to generate the predictive feature 412. In some embodiments, the first machine learning model 408 and/or the second machine learning model 410 is a supervised machine learning model. In this regard, in some embodiments, the first machine learning model 408 and/or the second machine learning model 410 may comprise a random forest regression model, a linear regression model, a support vector regression model, and/or the like. In some embodiments, the first machine learning model 408 and/or the second machine learning model 410 is trained and tested using a set of training entities (e.g., comprising a set of historical entities each associated with a set of historical entity attributes). The first machine learning model 408, for example, may be trained using a set of historical entity attributes (e.g., independent features) that is labelled with a historical training feature (e.g., a historical return rate for a healthcare provider) that may be treated as a dependent/target feature for the set of historical entity attributes. In addition, or alternatively, the second machine learning model 410 may be trained using a set of historical entity attributes (e.g., independent features) that that is labelled with a normalized supplemental attribute (e.g., an approximated return rate for a healthcare provider) that may be treated as a dependent/target feature for the set of historical entity attributes.

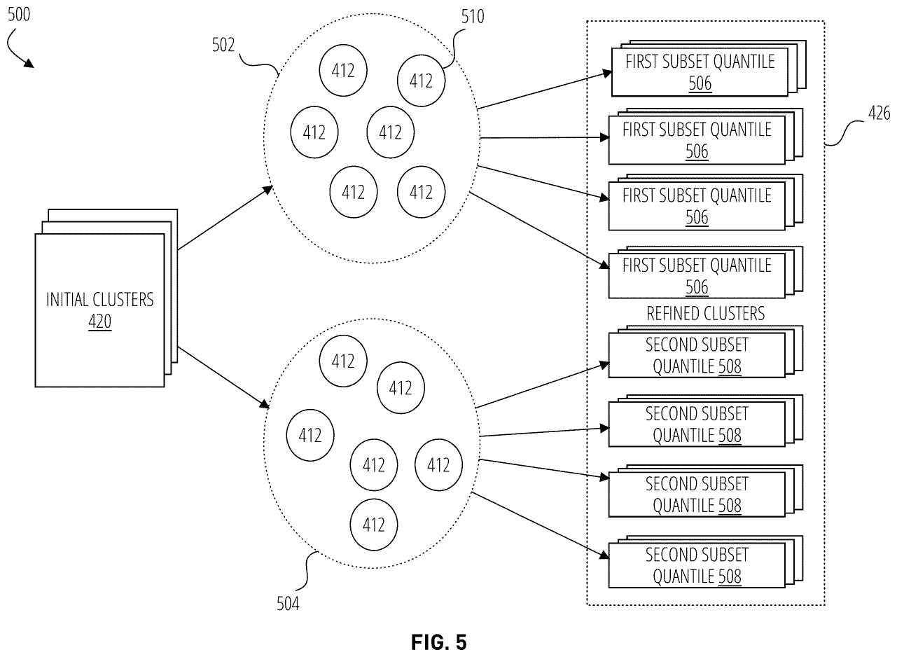

In some embodiments, at a second stage of the connected model framework 434, the computing system 101 generates, using the clustering model 418 of the connected model framework 434, a refined cluster 426 for the entity 436. The refined cluster 426 may be generated, as shown in greater detail in FIG. 5, by generating an initial cluster 420 for the entity 436 that comprise a first subset of the set of entities 438, generating, based on the predictive feature 412, a coefficient of variation for the initial cluster 420, and generating the refined cluster 426 from at least the initial cluster 420 based on the coefficient of variation.

More particularly, the computing system 101, using the clustering model 418 may sequentially cluster the set of entities 438 into different clusters based on their attributes and/or predictive features output by the supervised machine learning model 404 based on their attributes. For example, at a first clustering sequence, the computing system 101, using the clustering model 418 (e.g., k-means, expectation maximization, centroid neural network), may determine a set of initial clusters 420 for the set of entities 438 based on at least a subset of entity attributes indicated by individual entities of the set of entities 438. In some examples, at least the subset of the entity's attributes may first be encoded by an encoder model (e.g., t-distributed stochastic neighbor embedding (t-SNE), BERT, Word2Vec) as an embedding before determining the initial clusters 420 to which the embedding (and its associated entity) belongs, although in other examples, the raw entity attributes may be used for clustering. In some examples, during the first clustering sequence, the computing system 101 may determine the initial clusters 420 based on a subset (rather than all) of an entity's attributes. For example, an entity may comprise data that is more likely to be unique, such as a city or full name, that may be excluded from the clustering. Since attributes such as these are more likely to be unique and less likely to be predictive of similarity for the purposes discussed herein, these sorts of attributes may be excluded for clustering. In addition, or alternatively, the subset of the set of entity attributes 402 may be determined based on a key formatting ruleset 414 that defines a type of entity similarity for normalizing predictive features over a segment of interest (e.g., to selectively reduce bias based on bias detections and other machine learning performance deficiencies).

For example, the computing system 101 may generate a set of initial clusters 420 from the set of entities 438 based on a clustering key 416 for up to each of the set of entities 438. The clustering key 416 for an entity 436 may comprise a subset of entity attributes from the set of entity attributes 402. In some examples, the clustering key 416 may be based on a key formatting ruleset 414 that may define the subset of entity attributes from the set of entity attributes 402 in accordance with a normalization criterion. The normalization criterion may define a particular segment of interest, such as a work environment for in-office assessment predictions, a network environment for computer infrastructure predictions, and/or the like. The key formatting ruleset 414 define a subset of entity attributes that are unique to a particular segment of interest in order to cluster entries into different segments of interest that are configurable for a particular circumstance. By way of example, in a work environment use case, the subset of entity attributes may comprise geographic attribute, an engagement channel, a distribution channel, an engagement propensity, a member population level, and/or the like, that are reflective of a particular work environment in which a group of individuals may operate. In this manner, the key formatting ruleset 414 may define different homogenous entity attributes to identify different segments of interest within the set of entities 438.

The clustering key 416 and/or the key formatting ruleset 414 may be dynamically defined to modify the clustering model 418 based on the performance of the supervised machine learning model 404, the connected model framework 434, and/or biasing factors (e.g., real world observations that bias one segment of a cohort of data points) that may negatively influence supervised predictions for a particular use case. In this manner, the key formatting ruleset 414 may be leveraged as a configurable hyperparameter of the connected model framework to improve the adaptability, flexibility, maintainability, and/or the like of the connected model framework. For example, the key formatting ruleset 414 may be adjusted, extended, and/or updated (e.g., via a graphical user interface 440) to handle new data, such as new entity attributes, and/or to generate new clustering keys without requiring extensive changes to the supervised machine learning model 404, the clustering model 418, and/or the like of the connected model framework 434.

In some embodiments, the computing system 101, using the encoder model (e.g., t-distributed stochastic neighbor embedding (t-SNE), BERT, Word2Vec) of the clustering model 418, encodes the clustering key 416 of up to each of the set of entities 438 to generate a key embedding for up to each of the set of entities 438. In some example, the computing system 101, using an unsupervised machine learning model (e.g., k-means, expectation maximization, centroid neural network) of the clustering model 418, may cluster up to each of the set of entities 438 into a set of initial clusters based on their respective key embeddings. For example, the entity 436 may be clustered within another entity of the set of entities 438 to form an initial cluster of the set of initial clusters 420 based on an embedding similarity between their respective key embeddings.

In some embodiments, the computing system 101 preprocesses the subset of entity attributes of a clustering key 416 to prepare the clustering key 416 for an embedding process. For example, responsive to a determination that an entity attribute of the subset of entity attributes is a probabilistic value, the computing system may replace the probabilistic value with a deterministic value by assigning a categorical label to the entity 436 based on a set of probabilistic ranges corresponding to the entity attribute. For example, a probabilistic value of the entity attribute 402 may be categorized into a set of predefined ranges (e.g., bins) such that the probabilistic value of the entity attribute 402 may be transformed to a deterministic value (e.g., the probabilistic value is bucketized). The set of predefined ranges, for example, may comprise quantile bins, and/or another categorical value that identifies a relative magnitude of the probabilistic value of the entity 436 compared to the set of entities 438. The computing system may regenerate the clustering key 416 based on the deterministic value for the entity attribute.

In some embodiments, the computing system 101, using the clustering model 418, clusters up to each of the set of entities 438 to generate a set of initial clusters 420 that is passed to subsequent sequences of the clustering model 418 for further refinement. For example, the at the subsequent sequences of the clustering model 418, the computing system 101 may determine, based on a set of distribution and threshold metrics, such as the clustering size constraint 422, at least two cluster subsets from the set of initial clusters 420. The computing system may determine, based on a coefficient of variation for up to each of the set of initial clusters 420 within up to each of the at least two cluster subsets, a set of subset quantiles from up to each of the at least two cluster subsets. In some examples, the refined clusters 426 may comprise the set of subset quantiles.

More particularly, after the computing system 101 determines the set of initial clusters 420, and the subset of entities associated with up to each of the set of initial clusters, the computing system 101 may determine, based at least in part on the number of entities associated by clustering with up to each cluster, a first distribution (e.g., quartiles) of the number of entities clustered into each cluster (i.e., the cluster size). The computing system 101 may then divide the clusters into at least two cluster subsets based on the number of entities clustered into each of the set of initial clusters 420. For example, the computing system 101 may determine to include an initial cluster (and its respective subset of the set of entities 438) into a first cluster subset based on the number of entities associated with that initial cluster meeting or exceeding a clustering size constraint 422, such as a quartile, probability, and/or the like. Ultimately, the first cluster subset may comprise a subset of the set of initial clusters 420 (and its respective subsets of the set of entities 438) having cluster sizes that meet or exceed the clustering size constraint 422. In addition, or alternatively, a second cluster subset may comprise a second subset of the set of initial clusters 420 (and its respective subsets of the set of entities 438) having clusters that have cluster sizes that are below the clustering size constraint 422. For example, the first cluster subset may comprise a first subset of entities clustered into clusters having cluster sizes that meet or exceed a third quartile of the distribution, whereas the second cluster subset may comprise a second subset of entities clustered into clusters having cluster sizes that are below the third quartile of the distribution.

In some embodiments, the clustering size constraint 422 is a constraint that comprises a threshold value associated with an initial cluster to assign the initial cluster to a first cluster subset. For example, the clustering size constraint 422 may comprise a minimum number of entities (e.g., rows where entity attributes are columns) within an initial cluster. The minimum number may comprise a static parameter, such as ten, thirty-six, forty-five, one hundred, and/or the like. In addition, or alternatively, the minimum number may comprise a relative parameter, such as a first, second, third, quartile of a distribution of cluster sizes across the set of initial clusters 420.

In some examples, after the computing system 101 divides the set of initial clusters 420 into the at least two cluster subsets, the computing system 101, using the clustering model 418, may further divide the at least two cluster subsets into a set of refined clusters 426. For example, as described in further detail with reference to FIG. 5, the set of refined clusters 426 may comprise a set of subset quantiles (e.g., quartile) from the from up to each of the at least two cluster subsets. For example, the computing system may determine a metric (e.g., a coefficient of variation) of the predictive features 412 determined by the supervised machine learning model 404 for the subset of entities included in up to each of the initial clusters 420. In some examples, the computing system 101 may determine a distribution of the metric of the predictive features 412 within up to each of the cluster subsets. In other words, the computing system 101 may determine a first distribution of predictive features 412 for entities in the first cluster subset and a second distribution of predictive features 412 for entities in the second cluster subset. The computing system 101, using the clustering model 418, may determine thresholding metric(s) for up to each distribution, such as quantiles (e.g., quartiles), an average, a standard deviation, and/or the like, of the predictive features 412 themselves and/or a metric thereof, such as coefficient of variance determined for each of the initial clusters within a cluster subset. The computing system 101 may divide the initial clusters in up to each of the cluster subsets into a set of refined clusters 426 based on these metrics, such as two refined clusters depending on whether the predictive features 412 and/or metrics associated therewith (e.g., coefficients of variance) were above or below an average predictive feature and/or metric associated therewith (e.g., coefficient of variance), within/outside a standard deviation of the predictive feature and/or metric associated therewith (e.g., coefficients of variance), and/or the like.

In some embodiments, the computing system 101 generated the set of refined clusters 426 based on a coefficient of variation 424 of the predictive features 412 within up to each of the set of initial clusters 420 within up to each of the at least two cluster subsets. The coefficient of variation 424, for example, may comprise a value indicative of a ratio of the standard deviation of the predictive features associated with the entities in an initial cluster to the mean of the predictive features associated with the entities in the initial cluster. For example, if a first subset of the set of entities 438 comprises the entity 436 and a second entity, the coefficient of variation 424 may be the ratio of the standard deviation of the predictive feature 412 and a second predictive feature associated with the second entity to the mean of the predictive feature 412 and a second predictive feature associated with the second entity.

In some embodiments, the computing system 101 generates the set of refined clusters by dividing the subset of initial clusters within up to each of the at least two cluster subsets into a set of subset quantiles (e.g., quartile) based on the coefficient of variation 424 for up to each of the set of initial clusters 420. For example, the refined clusters 426 may comprise a set of first subset quantiles (e.g., four quartiles of initial clusters) from a first cluster subset of the at least two cluster subsets, a set of second subset quantiles (e.g., another four quartiles of initial clusters) from a second cluster subset of the at least two cluster subsets, and/or the like.

In some embodiments, the computing system 101 generates modified predictive feature 430 for the entity 436 based on the refined cluster 426 (e.g., a subset quantile in which the initial cluster of the entity is clustered) associated therewith. In some embodiments, the modified predictive feature 430 is a refined predicted value generated using the clustering model 418 of the connected model framework 434. For example, the modified predictive feature 430 may be a generalization of the predictive feature 412 that normalizes the feature with respect to a segment of the set of entities 438. By way of example, the modified predictive feature 430 may be a refined predicted return rate of in office assessments by the entity 436 that generalizes the prediction to a set of healthcare providers within similar work environments to prevent biasing underperforming or over performing providers. Another example, for a computer infrastructure domain, may comprise a refined predicted lifespan for a computer that generalizes the prediction to a set of computers within a similar network environment to prevent biasing over or underutilized computing devices.

In some embodiments, the computing system 101 generates the modified predictive feature 430 for the entity 436 by determining a lower bound feature from a set of predictive features 412 associated with a refined cluster 426. In some embodiments, the computing system 101 generates the modified predictive feature 430 for the entity 436 by determining an upper bound feature from a set of predictive features 412 associated with the refined cluster 426.

In some embodiments, the lower bound feature is a predicted value indicative of a lower limit value in a range of values associated with the one or more of the predictive features in the set of predictive features of a refined cluster 426. For example, the lower bound feature may be a value that is greater than or equal to 20-25 percent of the predictive features in the set of predictive features of a refined cluster 426. In some embodiments, the upper bound feature is a value indicative of an upper limit value in a range of values associated with one or more of the predictive features in the set of predictive features of a refined cluster 426. For example, the upper bound feature may be a value that is greater than or equal to 70-80 percent of the predictive features in the set of predictive features of a refined cluster 426.

In some embodiments, the computing system 101 generates the modified predictive feature 430 for the entity 436 by determining the modified predictive feature 430 based on the lower bound feature and/or the upper bound feature. For example, the computing system 101 may determine the modified predictive feature 430 based on an arithmetic mean of the upper bound feature and/or the lower bound feature. For example, the modified predictive feature 430 may be a value that is greater than 45-50 percent of the predictive features in the set of predictive features of a refined cluster 426.

In some embodiments, the computing system 101 outputs the modified predictive feature 430 for the entity 436 to a downstream process and/or a graphical user interface 440. In some examples, the computing system 101 may output the modified predictive feature 430 based on one or more pre-defined outputting rules and/or outputting criteria for the modified predictive feature 430 that, when executed, output one or more modified predictive feature 430 in response to a detection of an event corresponding to the entity. For example, the outputting rules and/or outputting criteria for the modified predictive feature 430 may define one or more timing events that describe a daily, weekly, quarterly, yearly and/or the like event triggers. In response to an event trigger, the computing system 101 may render, using the graphical user interface 440 associated with the entity, a graphical representation of the modified predictive feature 430 and/or contextual data, such as a progress towards the modified predictive feature 430, and/or the like.

FIG. 5 depicts an operational example 500 of a sequential clustering approach in accordance with some embodiments of the present disclosure. As depicted, and described herein, the sequential clustering approach comprises a series of clustering sequences that transform a set of initial clusters 420 into a set of refined clusters 426. In a clustering sequence subsequent to the initial clustering of the set of initial clusters 420, for example, the sequential clustering approach may comprise dividing the set of initial clusters 420 into at least two cluster subsets. The at least two cluster subsets, for example, may comprise a first cluster subset 502, a second cluster subset 504, and/or the like. In some examples, a feature metric 510, such as a coefficient of variation of a predictive feature distribution within an initial cluster, may be determined for up to each initial cluster within the first cluster subset 502, the second cluster subset 504, and/or the like. At a clustering sequence subsequent to the intermediate clustering of the cluster subsets, the sequential clustering approach may comprise dividing the cluster subsets (e.g., the first cluster subset 502 and the second cluster subset 504) into the set of refined clusters 426 based on the feature metric 510. The refined clusters 426, for example, may comprise a set of subset quantiles for up to each of the cluster subsets. By way of example, the sequential clustering approach may divide the first cluster subset 502 into a set of first subset quantiles 506 (e.g., four quartiles), the second cluster subset 504 into a set of second subset quantiles 508 (e.g., another four quartiles), and/or the like.

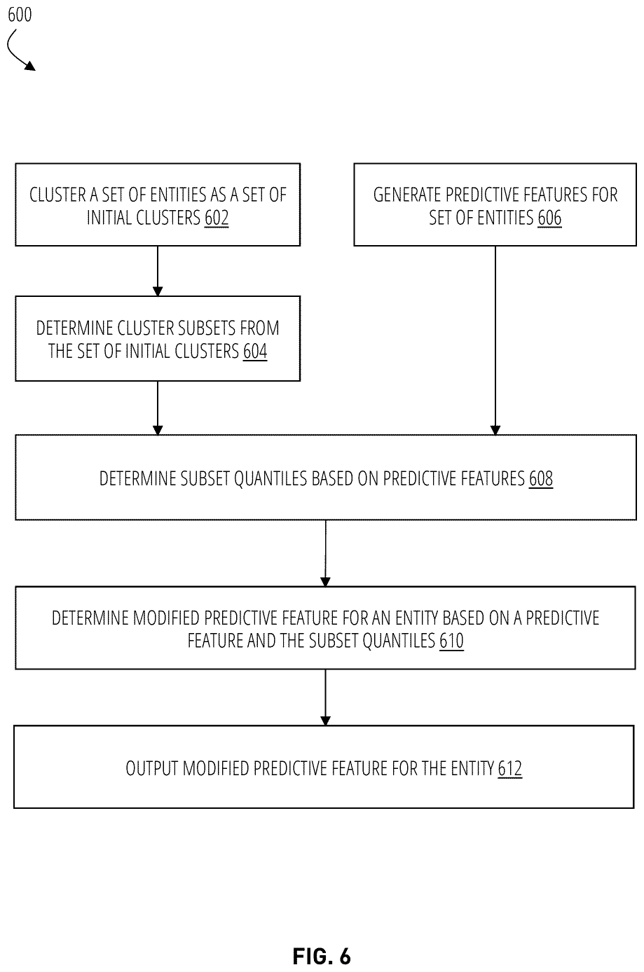

FIG. 6 depicts a flowchart diagram of an example hybrid machine learning process in accordance with some embodiments of the present disclosure. The flowchart diagram depicts a hybrid machine learning process that is performed using a connected model framework that comprises a variety machine learning models. The process 600 may be implemented by one or more computing devices, entities, and/or systems described herein. For example, via the various steps/operations of the process 600, the computing system 101 may automatically generate a predictive feature, generate a clustering key, generate an entity cluster, and output a modified predictive feature for the entity cluster. By doing so, the process 600 improves computer functionality by enabling improved predictions while reducing computing resource consumption. This, in turn, may improve the functionality of a computer with respect to various computing tasks, including increased functionality, machine learning, integration with downstream models, and/or the like.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, clustering a set of entities as a set of initial clusters. For example, the computing system 101 may generate, using a clustering model of a connected model framework, an initial cluster for the entity that comprises a first subset of the set of entities. In some examples, the computing system 101 may cluster the set of entities to generate the set of initial clusters and the initial cluster may comprise one of the set of initial clusters.

In some examples, the computing system 101 may generate the initial cluster based on a clustering key for the entity that comprises a subset of entity attributes from the set of entity attributes. For instance, the clustering key may be based on a key formatting ruleset that defines the subset of entity attributes from the set of entity attributes in accordance with a normalization criterion. In some examples, responsive to a determination that an entity attribute of the subset of entity attributes is a probabilistic value, the computing system 101 may replace the probabilistic value with a deterministic value by assigning a categorical label to the entity based on a set of probabilistic ranges corresponding to the entity attribute and generate the clustering key based on the deterministic value. In some examples, the computing system 101 may encode the clustering key to generate a key embedding for the entity and cluster, using an unsupervised machine learning model of the clustering model and based on the key embedding, the entity with another entity of the set of entities to form the initial cluster.

In some embodiments, the process 600 comprises, at operation 604, determining at least two cluster subsets from the set of initial clusters. For example, the computing system 101 may determine, based on a clustering size constraint, at least two cluster subsets from the set of initial clusters. In some examples, a first cluster subset of the at least two cluster subsets comprises the initial cluster.

In some embodiments, the process 600 comprises, at operation 606, generating a set of predictive features for the set of entities. In some examples, the operation 606 may be performed before, in parallel with, and/or sequentially to operations 602 and/or 604. For example, the computing system 101 may generate, using a supervised machine learning model of the connected model framework, a predictive feature for an entity of a set of entities based on a set of entity attributes corresponding to the entity. In some examples, the supervised machine learning model may comprise one of a supervised model set. The computing system 101 may, responsive to a first attribute of the set of entity attributes meeting or exceeding a time threshold, generate, using a first machine learning model of the supervised model set, the predictive feature for the entity. In addition, or alternatively, the computing system 101 may generate, using a second machine learning model of the supervised model set, the predictive feature for the entity. In some examples, the time threshold may be associated with a historical data threshold for the entity, the first machine learning model may generate the predictive feature using the set of entity attributes, and/or the second machine learning model may generate the predictive feature using the set of entity attributes and/or a normalized supplemental attribute for the entity.

In some embodiments, the process 600 comprises, at operation 608, determining a set of subset quantiles (e.g., refined clusters) based on the set of predictive features. For example, the computing system 101 may generate, using a clustering model of the connected model framework, a refined cluster for an entity by generating the initial cluster for the entity that comprises a first subset of the set of entities, generating, based on the predictive feature, a coefficient of variation for the initial cluster, and generating the refined cluster from the initial cluster based on the coefficient of variation. For instance, the computing system 101 may determine, based on the coefficient of variation, a set of subset quantiles from the first cluster subset and/or second cluster subset. In some examples, a refined cluster is one of a set of subset quantiles.

In some embodiments, the process 600 comprises, at operation 610, determining a set of modified predicted features from the set of predictive features based on the subset quantiles (e.g., refined clusters). For example, the computing system 101 may generate the modified predictive feature for the entity based on the refined cluster. For instance, the computing system 101 may determine a lower bound feature from a set of predictive features associated with the refined cluster. The computing system 101 may determine an upper bound feature from the set of predictive features associated with the refined cluster. The computing system 101 may determine the modified predictive feature based on the lower bound feature and/or the upper bound feature.

In some embodiments, the process 600 comprises, at operation 612, outputting the modified predictive features for the set of entities. For example, the computing system 101 may output the modified predictive feature to a downstream process and/or graphical user interface.

Some techniques of the present disclosure enable the generation of action outputs that may be performed to initiate one or more real world actions to achieve real-world effects. The techniques of the present disclosure may be used, applied, and/or otherwise leveraged to cause modified predictive features to be rendered on a graphical user interface and/or be implemented in downstream models. In some examples, the modified predictive features of the present disclosure may trigger action outputs (e.g., through control instructions) to automate entity operations and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.
Example 1. A computer-implemented method comprising generating, by one or more processors and using a supervised machine learning model of a connected model framework, a predictive feature for an entity of a set of entities based on a set of entity attributes corresponding to the entity; generating, by the one or more processors and using a clustering model of the connected model framework, a refined cluster for the entity by: (i) generating an initial cluster for the entity that comprises a first subset of the set of entities; (ii) generating, based on the predictive feature, a coefficient of variation for the initial cluster, and (iii) generating the refined cluster from the initial cluster based on the coefficient of variation; and generating, by the one or more processors, a modified predictive feature for the entity based on the refined cluster.
Example 2. The computer-implemented method of example 1, wherein the initial cluster is generated based on a clustering key for the entity that comprises a subset of entity attributes from the set of entity attributes.
Example 3. The computer-implemented method of example 2, further comprising, responsive to a determination that an entity attribute of the subset of entity attributes is a probabilistic value, (i) replacing the probabilistic value with a deterministic value by assigning a categorical label to the entity based on a set of probabilistic ranges corresponding to the entity attribute and (ii) generating the clustering key based on the deterministic value.
Example 4. The computer-implemented method of any of examples 2-3, wherein the clustering key is based on a key formatting ruleset that defines the subset of entity attributes from the set of entity attributes in accordance with a normalization criterion.
Example 5. The computer-implemented method of any of examples 2-4, wherein the initial cluster is generated by: encoding the clustering key to generate a key embedding for the entity; and clustering, using an unsupervised machine learning model of the clustering model and based on the key embedding, the entity with another entity of the set of entities to form the initial cluster.
Example 6. The computer-implemented method of any of the preceding examples, wherein the supervised machine learning model comprises one of a supervised model set and generating the predictive feature comprises: responsive to a first attribute of the set of entity attributes meeting or exceeding a time threshold, generating, using a first machine learning model of the supervised model set, the predictive feature for the entity; or generating, using a second machine learning model of the supervised model set, the predictive feature for the entity.
Example 7. The computer-implemented method of example 6, wherein the time threshold is associated with a historical data threshold for the entity, the first machine learning model generates the predictive feature using the set of entity attributes, and the second machine learning model generates the predictive feature using the set of entity attributes and a normalized supplemental attribute for the entity.
Example 8. The computer-implemented method of any of the preceding examples, wherein the modified predictive feature is generated by: determining a lower bound feature from a set of predictive features associated with the refined cluster; determining an upper bound feature from the set of predictive features associated with the refined cluster; and determining the modified predictive feature based on the lower bound feature and the upper bound feature.
Example 9. The computer-implemented method of any of the preceding examples, wherein generating the refined cluster for the entity further comprises: clustering the set of entities to generate a set of initial clusters, wherein the initial cluster is one of the set of initial clusters; determining, based on a clustering size constraint, at least two cluster subsets from the set of initial clusters, wherein a first cluster subset of the at least two cluster subsets comprises the initial cluster; and determining, based on the coefficient of variation, a set of subset quantiles from the first cluster subset, wherein the refined cluster is one of the set of subset quantiles.
Example 10. A system comprising: one or more processors; and one or more memories storing processor-executable instructions that, when executed by the one or more processors, cause the one or more processors to perform operations comprising: generating, using a supervised machine learning model of a connected model framework, a predictive feature for an entity of a set of entities based on a set of entity attributes corresponding to the entity; generating, using a clustering model of the connected model framework, a refined cluster for the entity by: (i) generating an initial cluster for the entity that comprises a first subset of the set of entities; (ii) generating, based on the predictive feature, a coefficient of variation for the initial cluster, and (iii) generating the refined cluster from the initial cluster based on the coefficient of variation; and generating a modified predictive feature for the entity based on the refined cluster.
Example 11. The system of example 10, wherein the initial cluster is generated based on a clustering key for the entity that comprises a subset of entity attributes from the set of entity attributes.
Example 12. The system of example 11, wherein the operations further comprise, responsive to a determination that an entity attribute of the subset of entity attributes is a probabilistic value, (i) replacing the probabilistic value with a deterministic value by assigning a categorical label to the entity based on a set of probabilistic ranges corresponding to the entity attribute and (ii) generating the clustering key based on the deterministic value.
Example 13. The system of any of examples 11-12, wherein the clustering key is based on a key formatting ruleset that defines the subset of entity attributes from the set of entity attributes in accordance with a normalization criterion.
Example 14. The system of any of examples 11-13, wherein the initial cluster is generated by: encoding the clustering key to generate a key embedding for the entity; and clustering, using an unsupervised machine learning model of the clustering model and based on the key embedding, the entity with another entity of the set of entities to form the initial cluster.
Example 15. The system of any of examples 10-14, wherein the supervised machine learning model comprises one of a supervised model set and generating the predictive feature comprises: responsive to a first attribute of the set of entity attributes meeting or exceeding a time threshold, generating, using a first machine learning model of the supervised model set, the predictive feature for the entity; or generating, using a second machine learning model of the supervised model set, the predictive feature for the entity.
Example 16. The system of example 15, wherein the time threshold is associated with a historical data threshold for the entity, the first machine learning model generates the predictive feature using the set of entity attributes, and the second machine learning model generates the predictive feature using the set of entity attributes and a normalized supplemental attribute for the entity.
Example 17. The system of any of examples 10-16, wherein the modified predictive feature is generated by: determining a lower bound feature from a set of predictive features associated with the refined cluster; determining an upper bound feature from the set of predictive features associated with the refined cluster; and determining the modified predictive feature based on the lower bound feature and the upper bound feature.
Example 18. One or more non-transitory computer-readable media storing processor-executable instructions that, when executed by one or more processors, cause the one or more processors to perform operations comprising: generating, using a supervised machine learning model of a connected model framework, a predictive feature for an entity of a set of entities based on a set of entity attributes corresponding to the entity; generating, using a clustering model of the connected model framework, a refined cluster for the entity by: (i) generating an initial cluster for the entity that comprises a first subset of the set of entities; (ii) generating, based on the predictive feature, a coefficient of variation for the initial cluster, and (iii) generating the refined cluster from the initial cluster based on the coefficient of variation; and generating a modified predictive feature for the entity based on the refined cluster.
Example 19. The one or more non-transitory computer-readable media of example 18, wherein the modified predictive feature is generated by: determining a lower bound feature from a set of predictive features associated with the refined cluster; determining an upper bound feature from the set of predictive features associated with the refined cluster; and determining the modified predictive feature based on the lower bound feature and the upper bound feature.
Example 20. The one or more non-transitory computer-readable media of any of examples 18-19, wherein generating the refined cluster for the entity further comprises: clustering the set of entities to generate a set of initial clusters, wherein the initial cluster is one of the set of initial clusters; determining, based on a clustering size constraint, at least two cluster subsets from the set of initial clusters, wherein a first cluster subset of the at least two cluster subsets comprises the initial cluster; and determining, based on the coefficient of variation, a set of subset quantiles from the first cluster subset, wherein the refined cluster is one of the set of subset quantiles.

1. A computer-implemented method comprising:
generating, by one or more processors and using a supervised machine learning model of a connected model framework, a predictive feature for an entity of a set of entities based on a set of entity attributes corresponding to the entity, wherein the predictive feature comprises an input into an unsupervised machine learning model of a clustering model of the connected model framework;
generating, by the one or more processors and using the unsupervised machine learning model of the clustering model of the connected model framework, a refined cluster for the entity by:
(i) generating an initial cluster for the entity that comprises a first subset of the set of entities;
(ii) generating, based on the predictive feature, a coefficient of variation for the initial cluster, and
(iii) generating the refined cluster from the initial cluster based on the coefficient of variation; and
generating, by the one or more processors, a modified predictive feature for the entity based on the refined cluster.

2. The computer-implemented method of claim 1, wherein the initial cluster is generated based on a clustering key for the entity that comprises a subset of entity attributes from the set of entity attributes.

3. The computer-implemented method of claim 2, further comprising, responsive to a determination that an entity attribute of the subset of entity attributes is a probabilistic value, (i) replacing the probabilistic value with a deterministic value by assigning a categorical label to the entity based on a set of probabilistic ranges corresponding to the entity attribute and (ii) generating the clustering key based on the deterministic value.

4. The computer-implemented method of claim 2, wherein the clustering key is based on a key formatting ruleset that defines the subset of entity attributes from the set of entity attributes in accordance with a normalization criterion.

5. The computer-implemented method of claim 2, wherein the initial cluster is generated by:
encoding the clustering key to generate a key embedding for the entity; and
clustering, using the unsupervised machine learning model of the clustering model and based on the key embedding, the entity with a second entity of the set of entities to form the initial cluster.

6. The computer-implemented method of claim 1, wherein the supervised machine learning model comprises one of a supervised model set and generating the predictive feature comprises:
responsive to a first attribute of the set of entity attributes meeting or exceeding a time threshold, generating, using a first machine learning model of the supervised model set, the predictive feature for the entity; or
generating, using a second machine learning model of the supervised model set, the predictive feature for the entity.

7. The computer-implemented method of claim 6, wherein the time threshold is associated with a historical data threshold for the entity, the first machine learning model generates the predictive feature using the set of entity attributes, and the second machine learning model generates the predictive feature using the set of entity attributes and a normalized supplemental attribute for the entity.

8. The computer-implemented method of claim 1, wherein the modified predictive feature is generated by:
determining a lower bound feature from a set of predictive features associated with the refined cluster;
determining an upper bound feature from the set of predictive features associated with the refined cluster; and
determining the modified predictive feature based on the lower bound feature and the upper bound feature.

9. The computer-implemented method of claim 1, wherein generating the refined cluster for the entity further comprises:
clustering the set of entities to generate a set of initial clusters, wherein the initial cluster is one of the set of initial clusters;
determining, based on a clustering size constraint, at least two cluster subsets from the set of initial clusters, wherein a first cluster subset of the at least two cluster subsets comprises the initial cluster; and
determining, based on the coefficient of variation, a set of subset quantiles from the first cluster subset, wherein the refined cluster is one of the set of subset quantiles.

10. A system comprising:
one or more processors; and
one or more memories storing processor-executable instructions that, when executed by the one or more processors, cause the one or more processors to perform operations comprising:
generating, using a supervised machine learning model of a connected model framework, a predictive feature for an entity of a set of entities based on a set of entity attributes corresponding to the entity, wherein the predictive feature comprises an input into an unsupervised machine learning model of a clustering model of the connected model framework;
generating, using the unsupervised machine learning model of the clustering model of the connected model framework, a refined cluster for the entity by:
(i) generating an initial cluster for the entity that comprises a first subset of the set of entities;
(ii) generating, based on the predictive feature, a coefficient of variation for the initial cluster, and
(iii) generating the refined cluster from the initial cluster based on the coefficient of variation; and
generating a modified predictive feature for the entity based on the refined cluster.

11. The system of claim 10, wherein the initial cluster is generated based on a clustering key for the entity that comprises a subset of entity attributes from the set of entity attributes.

12. The system of claim 11, wherein the operations further comprise, responsive to a determination that an entity attribute of the subset of entity attributes is a probabilistic value, (i) replacing the probabilistic value with a deterministic value by assigning a categorical label to the entity based on a set of probabilistic ranges corresponding to the entity attribute and (ii) generating the clustering key based on the deterministic value.

13. The system of claim 11, wherein the clustering key is based on a key formatting ruleset that defines the subset of entity attributes from the set of entity attributes in accordance with a normalization criterion.

14. The system of claim 11, wherein the initial cluster is generated by:
encoding the clustering key to generate a key embedding for the entity; and
clustering, using the unsupervised machine learning model of the clustering model and based on the key embedding, the entity with a second entity of the set of entities to form the initial cluster.

15. The system of claim 10, wherein the supervised machine learning model comprises one of a supervised model set and generating the predictive feature comprises:
responsive to a first attribute of the set of entity attributes meeting or exceeding a time threshold, generating, using a first machine learning model of the supervised model set, the predictive feature for the entity; or
generating, using a second machine learning model of the supervised model set, the predictive feature for the entity.

16. The system of claim 15, wherein the time threshold is associated with a historical data threshold for the entity, the first machine learning model generates the predictive feature using the set of entity attributes, and the second machine learning model generates the predictive feature using the set of entity attributes and a normalized supplemental attribute for the entity.

17. The system of claim 10, wherein the modified predictive feature is generated by:
determining a lower bound feature from a set of predictive features associated with the refined cluster;
determining an upper bound feature from the set of predictive features associated with the refined cluster; and
determining the modified predictive feature based on the lower bound feature and the upper bound feature.

18. One or more non-transitory computer-readable media storing processor-executable instructions that, when executed by one or more processors, cause the one or more processors to perform operations comprising:
generating, using a supervised machine learning model of a connected model framework, a predictive feature for an entity of a set of entities based on a set of entity attributes corresponding to the entity, wherein the predictive feature comprises an input into an unsupervised machine learning model of a clustering model of the connected model framework;
generating, using the unsupervised machine learning model of the clustering model of the connected model framework, a refined cluster for the entity by:
(i) generating an initial cluster for the entity that comprises a first subset of the set of entities;
(ii) generating, based on the predictive feature, a coefficient of variation for the initial cluster, and
(iii) generating the refined cluster from the initial cluster based on the coefficient of variation; and
generating a modified predictive feature for the entity based on the refined cluster.

19. The one or more non-transitory computer-readable media of claim 18, wherein the modified predictive feature is generated by:
determining a lower bound feature from a set of predictive features associated with the refined cluster;
determining an upper bound feature from the set of predictive features associated with the refined cluster; and
determining the modified predictive feature based on the lower bound feature and the upper bound feature.

20. The one or more non-transitory computer-readable media of claim 18, wherein generating the refined cluster for the entity further comprises:
clustering the set of entities to generate a set of initial clusters, wherein the initial cluster is one of the set of initial clusters;
determining, based on a clustering size constraint, at least two cluster subsets from the set of initial clusters, wherein a first cluster subset of the at least two cluster subsets comprises the initial cluster; and determining, based on the coefficient of variation, a set of subset quantiles from the first cluster subset, wherein the refined cluster is one of the set of subset quantiles.
